(19) United States
(12) Patent Application Publication
(10) Pub. No.: US 2015/0161981 A1
(43) Pub. Date: Jun. 11, 2015

(54) SYSTEMS AND METHODS FOR SHARING SECONDARY PATH INFORMATION BETWEEN AUDIO CHANNELS IN AN ADAPTIVE NOISE CANCELLATION SYSTEM

(71) Applicant: Cirrus Logic, Inc., Austin, TX (US)

(72) Inventor: Nitin Kwatra, Austin, TX (US)

(73) Assignee: Cirrus Logic, Inc., Austin, TX (US)

(21) Appl. No.: 14/101,893

(22) Filed: Dec. 10, 2013

(51) Int. Cl. G10K 11/175

(52) U.S. Cl. CPC G10K 11/175

(57) ABSTRACT

Systems and methods of the present disclosure include analyzing and comparing transfer functions associated with a plurality of electro-acoustic paths for transducers of a personal audio device to determine proximity of the transducers to respective ears of a listener of the personal audio device, quality of acoustic seals associated with the transducers, and for one or more other purposes.

### FIELD OF DISCLOSURE

The present disclosure relates in general to adaptive noise cancellation in connection with an acoustic transducer, and more particularly, to sharing information between audio channels in an adaptive noise cancellation system.

### BACKGROUND

Wireless telephones, such as mobile/cellular telephones, cordless telephones, and other consumer audio devices, such as mp3 players, are in widespread use. Performance of such devices with respect to intelligibility can be improved by providing noise canceling using a microphone to measure ambient acoustic events and then using signal processing to insert an anti-noise signal into the output of the device to cancel the ambient acoustic events. Because the acoustic environment around personal audio devices such as wireless telephones can change dramatically, depending on the sources of noise that are present and the position of the device itself, it is desirable to adapt the noise canceling to take into account such environmental changes.

Because the acoustic environment around personal audio devices, such as wireless telephones, can change dramatically, depending on the sources of noise that are present and the position of the device itself, it is desirable to adapt the noise canceling to take into account such environmental changes. For example, many adaptive noise canceling systems utilize an error microphone for sensing acoustic pressure proximate to an output of an electro-acoustic transducer (e.g., a loudspeaker) and generating an error microphone signal indicative of the acoustic output of the transducer and the ambient audio sounds at the transducer. When the transducer is close to a listener's ear, the error microphone signal may approximate the actual acoustic pressure at a listener's eardrum (a location known as a drum reference point). However, because of the distance between the drum reference point and the location of the error microphone (known as the error reference point), the error microphone signal is only an approximation and not a perfect indication of acoustic pressure at the drum reference point. Thus, because noise cancellation attempts to reduce ambient audio sounds present in the error microphone signal, performance of a noise cancellation system may be the greatest when the distance between the drum reference point and the error reference point is small. As the distance increases (e.g., transducer held against the ear at a lower pressure), the performance of the noise cancellation system may degrade, partly because the gain of the transfer function from the error reference point to the drum reference point decreases with such increased distance. This degradation is not accounted for in traditional adaptive noise cancellation systems.

### SUMMARY

In accordance with the teachings of the present disclosure, the disadvantages and problems associated with improving audio performance of a personal audio device may be reduced or eliminated.

In accordance with embodiments of the present disclosure, an integrated circuit for implementing at least a portion of a personal audio device may include a first output, a first error microphone input, a second output, a second error microphone input, and a processing circuit. The first output may provide a first output signal to a first transducer including both a first source audio signal for playback to a listener and a first anti-noise signal for countering the effect of ambient audio sounds in an acoustic output of the first transducer. The first error microphone input may receive a first error microphone signal indicative of the output of the first transducer and the ambient audio sounds at the first transducer. The second output may provide a second output signal to a second transducer including both a second source audio signal for playback to the listener and a second anti-noise signal for countering the effect of ambient audio sounds in an acoustic output of the second transducer. The second error microphone input may receive a second error microphone signal indicative of the output of the second transducer and the ambient audio sounds at the second transducer. The processing circuit may implement a first secondary path estimate adaptive filter for modeling an electro-acoustic path of the first source audio signal through the first transducer and having a response that generates a first secondary path estimate signal from the first source audio signal, a first coefficient control block that shapes the response of the first secondary path estimate adaptive filter in conformity with the first source audio signal and a first playback corrected error by adapting the response of the first secondary path estimate filter to minimize the first playback corrected error, wherein the first playback corrected error is based on a difference between the first error microphone signal and the first secondary path estimate signal, a second secondary path estimate adaptive filter for modeling an electro-acoustic path of the second source audio signal through the second transducer and having a response that generates a second secondary path estimate signal from the second source audio signal, a second coefficient control block that shapes the response of the second secondary path estimate adaptive filter in conformity with the second source audio signal and a second playback corrected error by adapting the response of the second secondary path estimate filter to minimize the second playback corrected error, wherein the second playback corrected error is based on a difference between the second error microphone signal and the second secondary path estimate signal, a first filter that generates the first anti-noise signal to reduce the presence of the ambient audio sounds at the acoustic output of the first transducer based at least on the first playback corrected error, a second filter that generates the second anti-noise signal to reduce the presence of the ambient audio sounds at the acoustic output of the second transducer based at least on the second playback corrected error, and a comparison block that compares the response of the first secondary path estimate adaptive filter and the response of the second secondary path estimate adaptive filter.

In accordance with these and other embodiments of the present disclosure, a method for canceling ambient audio sounds in the respective proximities of transducers associated with a personal audio device may include receiving a first error microphone signal indicative of an output of a first transducer and the ambient audio sounds at the first transducer. The method may also include receiving a second error microphone signal indicative of an output of a second transducer and the ambient audio sounds at the second transducer. The method may also include generating a first secondary path estimate signal from a first source audio signal by filtering the first source audio signal with a first secondary path estimate filter for modeling an electro-acoustic path of the source audio signal through the first transducer, wherein a response of the first secondary path estimate adaptive filter is shaped in conformity with the first source audio signal and a first playback corrected error by adapting the response of the first secondary path estimate filter to minimize the first playback corrected error, wherein the first playback corrected error is based on a difference between the first error microphone signal and the first secondary path estimate signal. The method may additionally include generating a second secondary path estimate signal from a second source audio signal by filtering the second source audio signal with a second secondary path estimate filter for modeling an electro-acoustic path of the second source audio signal through the second transducer wherein a response of the second secondary path estimate adaptive filter is shaped in conformity with the second source audio signal and a second playback corrected error by adapting the response of the second secondary path estimate filter to minimize the second playback corrected error, wherein the second playback corrected error is based on a difference between the second error microphone signal and the second secondary path estimate signal. The method may additionally include generating a first anti-noise signal to reduce the presence of the ambient audio sounds at the acoustic output of the first transducer based at least on the first playback corrected error. The method may further include generating a second anti-noise signal to reduce the presence of the ambient audio sounds at the acoustic output of the second transducer based at least on the second playback corrected error. The method may further include comparing the response of the first secondary path estimate adaptive filter and the response of the second secondary path estimate adaptive filter.

In accordance with these and other embodiments of the present disclosure, an integrated circuit for implementing at least a portion of a personal audio device may include a first output, a first error microphone input, a first reference microphone input, a second output, a second error microphone input, a second reference microphone input, and a processing circuit. The first output may provide a first output signal to a first transducer including both a first source audio signal for playback to a listener and a first anti-noise signal for countering the effect of ambient audio sounds in an acoustic output of the first transducer. The first error microphone input may receive a first error microphone signal indicative of the output of the first transducer and the ambient audio sounds at the first transducer. The first reference microphone input may receive a first reference microphone signal indicative of the ambient audio sounds at the acoustic output of the first transducer. The second output may provide a second output signal to a second transducer including both a second source audio signal for playback to the listener and a second anti-noise signal for countering the effect of ambient audio sounds in an acoustic output of the second transducer. The second error microphone input may receive a second error microphone signal indicative of the output of the second transducer and the ambient audio sounds at the second transducer. The second reference microphone input may receive a second reference microphone signal indicative of the ambient audio sounds at the acoustic output of the second transducer. The processing circuit may implement a first adaptive filter that generates the first anti-noise signal from the first reference microphone signal to reduce the presence of the ambient audio sounds at the acoustic output of the first transducer, a second adaptive filter that generates the second anti-noise signal from the second reference microphone signal to reduce the presence of the ambient audio sounds at the acoustic output of the second transducer, a first coefficient control block that shapes the response of the first adaptive filter in conformity with the first error microphone signal and the first reference microphone signal by adapting the response of the first adaptive filter to minimize the ambient audio sounds in the first error microphone signal, a second coefficient control block that shapes the response of the second adaptive filter in conformity with the second error microphone signal and the second reference microphone signal by adapting the response of the second adaptive filter to minimize the ambient audio sounds in the second error microphone signal, and a comparison block that compares the response of the first adaptive filter and the response of the second adaptive filter.

In accordance with these and other embodiments of the present disclosure, a method for canceling ambient audio sounds in the respective proximities of transducers associated with a personal audio device may include receiving a first error microphone signal indicative of an output of a first transducer and the ambient audio sounds at the first transducer, receiving a second error microphone signal indicative of an output of a second transducer and the ambient audio sounds at the second transducer, receiving a first reference microphone signal indicative of the ambient audio sounds at the acoustic output of the first transducer, and receiving a second reference microphone signal indicative of the ambient audio sounds at the acoustic output of the second transducer. The method may also include generating, by a first adaptive filter, a first anti-noise signal from the first reference microphone signal to reduce the presence of the ambient audio sounds at the acoustic output of the first transducer and generating, by a second adaptive filter, a second anti-noise signal from the second reference microphone signal to reduce the presence of the ambient audio sounds at the acoustic output of the second transducer. The method may additionally include shaping, by a first anti-noise path coefficient control block, a response of the first filter in conformity with the first error microphone signal and the first reference microphone signal by adapting the response of the first filter to minimize the ambient audio sounds in the first error microphone signal and shaping, by a second anti-noise path coefficient control block, a response of the second filter in conformity with the second error microphone signal and the second reference microphone signal by adapting the response of the second filter to minimize the ambient audio sounds in the second error microphone signal. The method may further include comparing the response of the first adaptive filter and the response of the second adaptive filter.

Technical advantages of the present disclosure may be readily apparent to one of ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1A is an illustration of an example personal audio device, in accordance with embodiments of the present disclosure;

FIG. 1B is an illustration of an example personal audio device with a headphone assembly coupled thereto, in accordance with embodiments of the present disclosure;

FIG. 2 is a block diagram of selected circuits within the personal audio device depicted in FIGS. 1A and 1B, in accordance with embodiments of the present disclosure;

FIG. 3 is a block diagram depicting selected signal processing circuits and functional blocks within an example active noise canceling (ANC) circuit of a coder-decoder (CODEC) integrated circuit of FIG. 3, in accordance with embodiments of the present disclosure;

FIG. 4 is a block diagram depicting selected circuits associated with two audio channels within the personal audio device depicted in FIGS. 1A and 1B, in accordance with embodiments of the present disclosure; and

FIG. 5 is a flow chart depicting an example method for controlling generation of anti-noise by an ANC system based on comparison of secondary path information between audio channels of the personal audio device.

### DETAILED DESCRIPTION

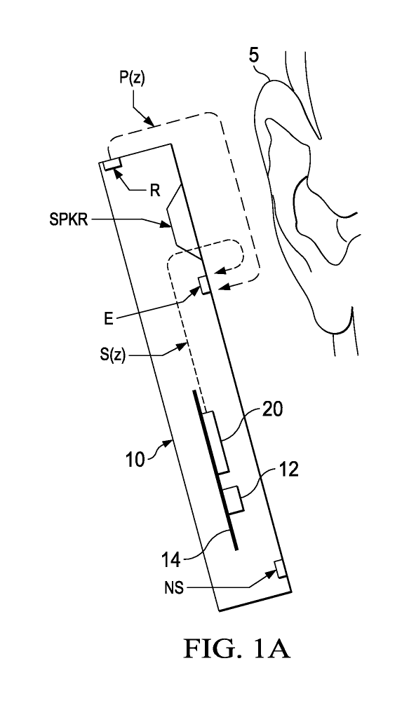

Referring now to FIG. 1A, a personal audio device 10 as illustrated in accordance with embodiments of the present disclosure is shown in proximity to a human ear 5. Personal audio device 10 is an example of a device in which techniques in accordance with embodiments of the invention may be employed, but it is understood that not all of the elements or configurations embodied in illustrated personal audio device 10, or in the circuits depicted in subsequent illustrations, are required in order to practice the invention recited in the claims. Personal audio device 10 may include a transducer such as speaker SPKR that reproduces distant speech received by personal audio device 10, along with other local audio events such as ringtones, stored audio program material, injection of near-end speech (i.e., the speech of the user of personal audio device 10) to provide a balanced conversational perception, and other audio that requires reproduction by personal audio device 10, such as sources from webpages or other network communications received by personal audio device 10 and audio indications such as a low battery indication and other system event notifications. A near-speech microphone NS may be provided to capture near-end speech, which is transmitted from personal audio device 10 to the other conversation participant(s).

Personal audio device 10 may include adaptive noise cancellation (ANC) circuits and features that inject an anti-noise signal into speaker SPKR to improve intelligibility of the distant speech and other audio reproduced by speaker SPKR. A reference microphone R may be provided for measuring the ambient acoustic environment, and may be positioned away from the typical position of a user's mouth, so that the near-end speech may be minimized in the signal produced by reference microphone R. Another microphone, error microphone E, may be provided in order to further improve the ANC operation by providing a measure of the ambient audio combined with the audio reproduced by speaker SPKR close to ear 5, when personal audio device 10 is in close proximity to ear 5. Circuit 14 within personal audio device 10 may include an audio CODEC integrated circuit (IC) 20 that receives the signals from reference microphone R, near-speech microphone NS, and error microphone E, and interfaces with other integrated circuits such as a radio-frequency (RF) integrated circuit 12 having a personal audio device transceiver. In some embodiments of the disclosure, the circuits and techniques disclosed herein may be incorporated in a single integrated circuit that includes control circuits and other functionality for implementing the entirety of the personal audio device, such as an MP3 player-on-a-chip integrated circuit. In these and other embodiments, the circuits and techniques disclosed herein may be implemented partially or fully in software and/or firmware embodied in computer-readable media and executable by a controller or other processing device.

In general, ANC techniques of the present disclosure measure ambient acoustic events (as opposed to the output of speaker SPKR and/or the near-end speech) impinging on reference microphone R, and by also measuring the same ambient acoustic events impinging on error microphone E, ANC processing circuits of personal audio device 10 adapt an anti-noise signal generated out the output of speaker SPKR from the output of reference microphone R to have a characteristic that minimizes the amplitude of the ambient acoustic events at error microphone E. Because acoustic path P(z) extends from reference microphone R to error microphone E, ANC circuits are effectively estimating acoustic path P(z) while removing effects of an electro-acoustic path S(z) that represents the response of the audio output circuits of CODEC IC 20 and the acoustic/electric transfer function of speaker SPKR including the coupling between speaker SPKR and error microphone E in the particular acoustic environment, which may be affected by the proximity and structure of ear 5 and other physical objects and human head structures that may be in proximity to personal audio device 10, when personal audio device 10 is not firmly pressed to ear 5. While the illustrated personal audio device 10 includes a two-microphone ANC system with a third near-speech microphone NS, some aspects of the present invention may be practiced in a system that does not include separate error and reference microphones, or a personal audio device that uses near-speech microphone NS to perform the function of the reference microphone R. Also, in personal audio devices designed only for audio playback, near-speech microphone NS will generally not be included, and the near-speech signal paths in the circuits described in further detail below may be omitted, without changing the scope of the disclosure, other than to limit the options provided for input to the microphone covering detection schemes. In addition, although only one reference microphone R is depicted in FIG. 1, the circuits and techniques herein disclosed may be adapted, without changing the scope of the disclosure, to personal audio devices including a plurality of reference microphones.

Referring now to FIG. 1B, personal audio device 10 is depicted having a headphone assembly 13 coupled to it via audio port 15. Audio port 15 may be communicatively coupled to RF integrated circuit 12 and/or CODEC IC 20, thus permitting communication between components of headphone assembly 13 and one or more of RF integrated circuit 12 and/or CODEC IC 20. As shown in FIG. 1B, headphone assembly 13 may include a combox 16, a left headphone 18A, and a right headphone 18B. As used in this disclosure, the term “headphone” broadly includes any loudspeaker and structure associated therewith that is intended to be mechanically held in place proximate to a listener's ear or ear canal, and includes without limitation earphones, earbuds, and other similar devices. As more specific non-limiting examples, “headphone,” may refer to intra-canal earphones, intra-concha earphones, supra-concha earphones, and supra-aural earphones.

Combox 16 or another portion of headphone assembly 13 may have a near-speech microphone NS to capture near-end speech in addition to or in lieu of near-speech microphone NS of personal audio device 10. In addition, each headphone 18A, 18B may include a transducer such as speaker SPKR that reproduces distant speech received by personal audio device 10, along with other local audio events such as ringtones, stored audio program material, injection of near-end speech (i.e., the speech of the user of personal audio device 10) to provide a balanced conversational perception, and other audio that requires reproduction by personal audio device 10, such as sources from webpages or other network communications received by personal audio device 10 and audio indications such as a low battery indication and other system event notifications. Each headphone 18A, 18B may include a reference microphone R for measuring the ambient acoustic environment and an error microphone E for measuring of the ambient audio combined with the audio reproduced by speaker SPKR close to a listener's ear when such headphone 18A, 18B is engaged with the listener's ear. In some embodiments, CODEC IC 20 may receive the signals from reference microphone R, near-speech microphone NS, and error microphone E of each headphone and perform adaptive noise cancellation for each headphone as described herein. In other embodiments, a CODEC IC or another circuit may be present within headphone assembly 13, communicatively coupled to reference microphone R, near-speech microphone NS, and error microphone E, and configured to perform adaptive noise cancellation as described herein.

The various microphones referenced in this disclosure, including reference microphones, error microphones, and near-speech microphones, may comprise any system, device, or apparatus configured to convert sound incident at such microphone to an electrical signal that may be processed by a controller, and may include without limitation an electrostatic microphone, a condenser microphone, an electret microphone, an analog microelectromechanical systems (MEMS) microphone, a digital MEMS microphone, a piezoelectric microphone, a piezo-ceramic microphone, or dynamic microphone.

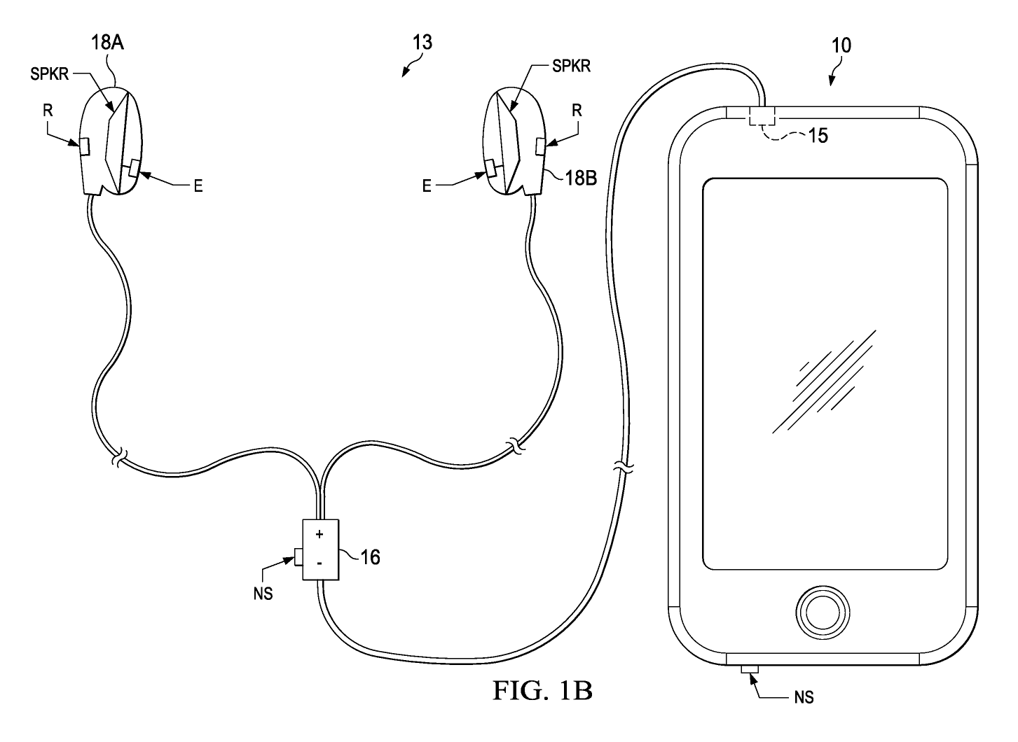

Referring now to FIG. 2, selected circuits within personal audio device 10, which in other embodiments may be placed in whole or part in other locations such as one or more headphone assemblies 13, are shown in a block diagram. CODEC IC 20 may include an analog-to-digital converter (ADC) 21A for receiving the reference microphone signal and generating a digital representation ref of the reference microphone signal, an ADC 21B for receiving the error microphone signal and generating a digital representation err of the error microphone signal, and an ADC 21C for receiving the near speech microphone signal and generating a digital representation ns of the near speech microphone signal. CODEC IC 20 may generate an output for driving speaker SPKR from an amplifier Al, which may amplify the output of a digital-to-analog converter (DAC) 23 that receives the output of a combiner 26. Combiner 26 may combine audio signals is from internal audio sources 24, the anti-noise signal generated by ANC circuit 30, which by convention has the same polarity as the noise in reference microphone signal ref and is therefore subtracted by combiner 26, and a portion of near speech microphone signal ns so that the user of personal audio device 10 may hear his or her own voice in proper relation to downlink speech ds, which may be received from radio frequency (RF) integrated circuit 22 and may also be combined by combiner 26. Near speech microphone signal ns may also be provided to RF integrated circuit 22 and may be transmitted as uplink speech to the service provider via antenna ANT.

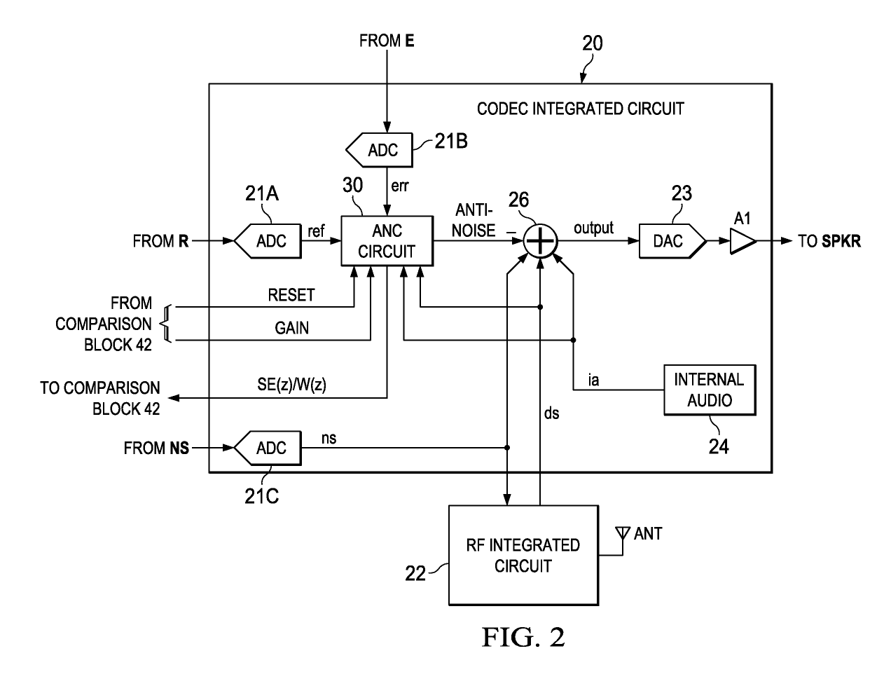

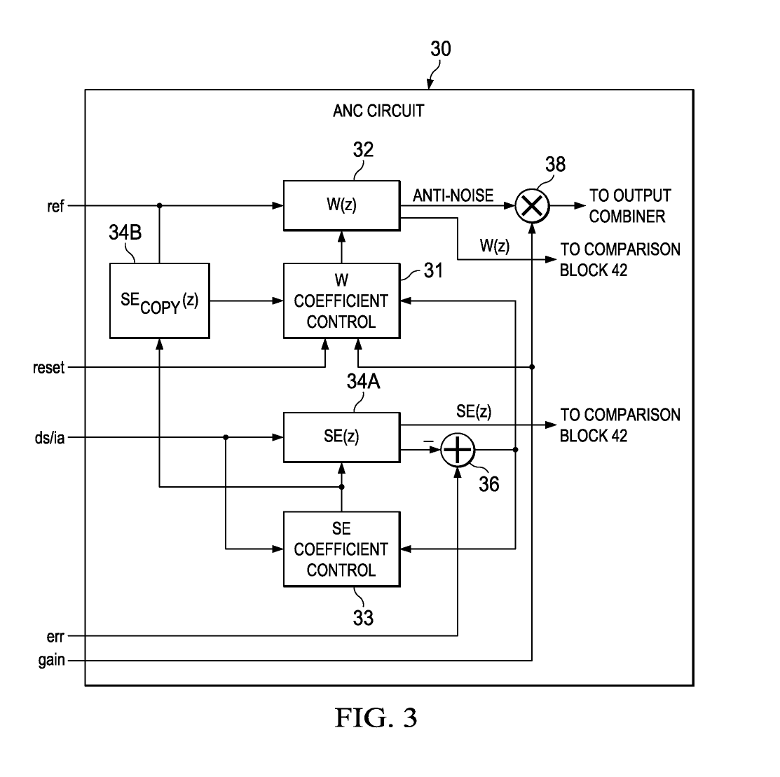

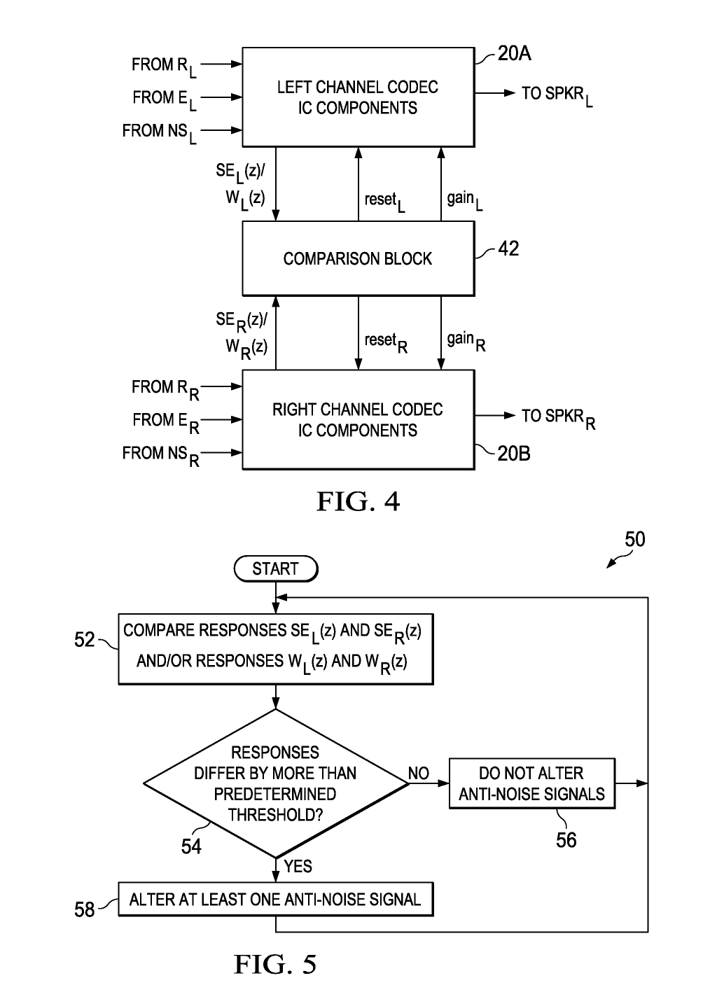

Referring now to FIG. 3, details of ANC circuit 30 are shown in accordance with embodiments of the present disclosure. Adaptive filter 32 may receive reference microphone signal ref and under ideal circumstances, may adapt its transfer function W(z) to be P(z)/S(z) to generate the anti-noise signal, which may be provided to an output combiner that combines the anti-noise signal with the audio to be reproduced by the transducer, as exemplified by combiner 26 of FIG. 2. The coefficients of adaptive filter 32 may be controlled by a W coefficient control block 31 that uses a correlation of signals to determine the response of adaptive filter 32, which generally minimizes the error, in a least-mean squares sense, between those components of reference microphone signal ref present in error microphone signal err. The signals compared by W coefficient control block 31 may be the reference microphone signal ref as shaped by a copy of an estimate of the response of path S(z) provided by filter 34B and another signal that includes error microphone signal err. By transforming reference microphone signal ref with a copy of the estimate of the response of path S(z), response SE_{COPY}(z), and minimizing the difference between the resultant signal and error microphone signal err, adaptive filter 32 may adapt to the desired response of P(z)/S(z). In addition to error microphone signal err, the signal compared to the output of filter 34B by W coefficient control block 31 may include an inverted amount of downlink audio signal ds and/or internal audio signal ia that has been processed by filter response SE(z), of which response SE_{COPY}(z) is a copy. By injecting an inverted amount of downlink audio signal ds and/or internal audio signal ia, adaptive filter 32 may be prevented from adapting to the relatively large amount of downlink audio and/or internal audio signal present in error microphone signal err and by transforming that inverted copy of downlink audio signal ds and/or internal audio signal ia with the estimate of the response of path S(z), the downlink audio and/or internal audio that is removed from error microphone signal err before comparison should match the expected version of downlink audio signal ds and/or internal audio signal ia reproduced at error microphone signal err, because the electrical and acoustical path of S(z) is the path taken by downlink audio signal ds and/or internal audio signal ia to arrive at error microphone E. As shown in FIGS. 2 and 3, W coefficient control block 31 may also reset signal from a comparison block 42, as described in greater detail below in connection with FIGS. 4 and 5.

Filter 34B may not be an adaptive filter, per se, but may have an adjustable response that is tuned to match the response of adaptive filter 34A, so that the response of filter 34B tracks the adapting of adaptive filter 34A.

To implement the above, adaptive filter 34A may have coefficients controlled by SE coefficient control block 33, which may compare downlink audio signal ds and/or internal audio signal ia and error microphone signal err after removal of the above-described filtered downlink audio signal ds and/or internal audio signal ia, that has been filtered by adaptive filter 34A to represent the expected downlink audio delivered to error microphone E, and which is removed from the output of adaptive filter 34A by a combiner 36. SE coefficient control block 33 correlates the actual downlink speech signal ds and/or internal audio signal ia with the components of downlink audio signal ds and/or internal audio signal ia that are present in error microphone signal err. Adaptive filter 34A may thereby be adapted to generate a signal from downlink audio signal ds and/or internal audio signal ia, that when subtracted from error microphone signal err, contains the content of error microphone signal err that is not due to downlink audio signal ds and/or internal audio signal ia.

Also as depicted in FIG. 3, a path of the anti-noise signal may have a programmable gain element 38, such that an increased gain will cause increase of the anti-noise signal combined at output combiner 26 and a decreased gain will cause decrease of the anti-noise signal combined at output combiner 26. As described in greater detail below with respect to FIGS. 4 and 5, the gain of programmable gain element 38 may vary based on a gain signal received from comparison block 42.

For clarity of exposition, the components of audio IC circuit 20 shown in FIGS. 2 and 3 depict components associated with only one audio channel. However, in personal audio devices employing stereo audio (e.g., those with headphones) many components of audio CODEC IC 20 shown in FIGS. 2 and 3 may be duplicated, such that each of two audio channels (e.g., one for a left-side transducer and one for a right-side transducer) are independently capable of performing ANC.

Turning to FIG. 4, a system is shown including left channel CODEC IC components 20A, right channel CODEC IC components 20B, and a comparison block 42. Each of left channel CODEC IC components 20A and right channel CODEC IC components 20B may comprise some or all of the various components of CODEC IC 20 depicted in FIG. 2. Thus, based on a respective reference microphone signal (e.g., from reference microphone R_{L} or R_{R}), a respective error microphone signal (e.g., from error microphone E_{L} or E_{R}), a respective near-speech microphone signal (e.g., from near-sppech microphone NS_{L} or NS_{R}), and/or other signals, an ANC circuit 30 associated with a respective audio channel may generate an anti-noise signal, which may be combined with a source audio signal and communicated to a respective transducer (e.g., SPKR_{L} or SPKR_{R}).

Comparison block 42 may be configured to receive from each of left channel CODEC IC components 20A and right channel CODEC IC components 20B a signal indicative of the response SE(z) of the secondary estimate adaptive filter 34A of the channel, shown in FIG. 4 as responses SE_{L}(z) and SE_{R}(z), and compare such responses. Comparison of the responses of the secondary estimate adaptive filters 34A may be indicative of a proximity of each of the transducers SPKR_{L} and SPKR_{R} to a respective ear of a listener, indicative of a quality of an acoustic seal between each of the transducers SPKR_{L} and SPKR_{R} to a respective ear of the listener, and/or indicative of other physical properties of transducers SPKR_{L} and/or SPKR_{R}. Based on such comparison, comparison block 42 may generate to one or both of left channel CODEC IC components 20A and right channel CODEC IC components 20B a reset signal (e.g., reset_{L}, reset_{R}) and/or a gain signal (e.g., gain_{L}, gain_{R}) in order to alter one or both of the anti-noise signals generated by left channel CODEC IC components 20A and right channel CODEC IC components 20B. In some embodiments, such alteration may be independent of a response of a filter (e.g., adaptive filter 32) generating such anti-noise signal. For example, in such embodiments, a filter (e.g., adaptive filter 32) may generate an anti-noise signal for attempting to reduce presence of ambient audio sounds in an audio output signal at a transducer, wherein such anti-noise signal may be altered (e.g., attenuated) by a gain signal generated by comparison block 42 and communicated to gain element 38. In such embodiments, the adaptive filter 32 generating the anti-signal altered by gain element 38 may be frozen (e.g., prevented from adapting) when the gain of gain element 38 is other than a unity gain, otherwise adaptive filter 32 may attempt to adapt to the attenuated anti-noise signal. To freeze adaptation of the response of adaptive filter 32, adaptive filter 32 or coefficient control block 31 may be configured to cease adaptation when gain of gain element 38 is non-unity (e.g., as shown in FIG. 3, coefficient control block 31 may receive the gain signal from comparison block 42, and may be configured to cease update of coefficients when the gain signal indicates a non-zero gain).

In these and other embodiments, such alteration may include altering a response of the filter (e.g., adaptive filter 32) generating such anti-noise signal. For example, in such embodiments, coefficients of W coefficient control 31 may be reset to an initial value based on a reset signal generated by comparison block 42.

In these and other embodiments, after the anti-noise signal of a particular channel is altered in response to the responses SE(z) of secondary estimate adaptive filters 34A differing by more than a predetermined threshold, the ANC circuit 30 of such channel may reset coefficients of its respective SE coefficient control block 33 to be substantially equal to those of the other SE coefficient control block 33, to provide a starting point for adaptation once the condition (e.g., lack of proximity between transducer and listener's ear) leading to alteration of the anti-noise is remedied.

Although the foregoing discussion contemplates comparison of responses SE(z) of secondary estimate adaptive filters 34A and altering a response of an anti-noise signal in response to the comparison, it should be understood that ANC circuits 30 may compare responses of other elements of ANC circuits 30 and alter anti-noise signals based on such comparisons alternatively or in addition to the comparisons of responses SE(z). For example, in some embodiments, comparison block 42 may be configured to receive from each of left channel CODEC IC components 20A and right channel CODEC IC components 20B a signal indicative of the response W(z) of the adaptive filter 32A of the channel, shown in FIG. 4 as responses W_{L}(z) and W_{R}(z), and compare such responses. Comparison of the responses of the adaptive filters 32A may be indicative of a proximity of each of the transducers SPKR_{L} and SPKR_{R} to a respective ear of a listener, indicative of a quality of an acoustic seal between each of the transducers SPKR_{L} and SPKR_{R} to a respective ear of the listener, and/or indicative of other physical properties of transducers SPKR_{L} and/or SPKR_{R}. Based on such comparison, comparison block 42 may generate to one or both of left channel CODEC IC components 20A and right channel CODEC IC components 20B a reset signal (e.g., reset_{L}, reset_{R}) and/or a gain signal (e.g., gain_{L}, gain_{R}) in order to alter (e.g., attenuate) one or both of the anti-noise signals generated by left channel CODEC IC components 20A and right channel CODEC IC components 20B.

FIG. 5 illustrates a flow chart depicting an example method 50 for controlling generation of anti-noise by an ANC system based on comparison of secondary path information between audio channels of the personal audio device. According to one embodiment, method 50 may begin at step 52. As noted above, teachings of the present disclosure may be implemented in a variety of configurations of CODEC IC 20. As such, the preferred initialization point for method 50 and the order of the steps comprising method 50 may depend on the implementation chosen.

At step 52, comparison block 42 or another component of CODEC IC 20 may compare responses SE_{L}(z) and SE_{R}(z) of secondary estimate adaptive filters 34A and/or compare responses W_{L}(z) and W_{R}(z) of adaptive filters 32. At step 54, comparison block 42 or another component of CODEC IC 20 may determine if the responses SE_{L}(z) and SE_{R}(z) differ by more than a predetermined threshold and/or responses W_{L}(z) and W_{R}(z) differ by more than the same or another predetermined threshold. If the responses SE_{L}(z) and SE_{R}(z) differ by more than a predetermined threshold and/or if responses W_{L}(z) and W_{R}(z) differ by more than the same or another predetermined threshold, method 50 may proceed to step 58, otherwise method 50 may proceed to step 56.

At step 56, responsive to a determination that responses SE_{L}(z) and SE_{R}(z) do not differ by more than a predetermined threshold and/or that responses W_{L}(z) and W_{R}(z) do not differ by more than the same or another predetermined threshold, anti-noise signals generated by each of left channel CODEC IC components 20A and right channel CODEC IC components 20B may be unaltered. After completion of step 56, method 50 may proceed again to step 52.

At step 58, responsive to a determination that responses SE_{L}(z) and SE_{R}(z) differ by more than a predetermined threshold and/or that responses W_{L}(z) and W_{R}(z) differ by more than the same or another predetermined threshold, anti-noise signals generated by one or both of left channel CODEC IC components 20A and right channel CODEC IC components 20B may be altered. As mentioned above, such alteration may include varying a gain applied to an anti-noise signal in order to attenuate (including muting by attenuating with a zero gain) the anti-noise signal before it is reproduced by a transducer, and/or may include further altering response W(z) of adaptive filter 32 by resetting coefficients of W coefficient control 31 to a predetermined initial value. After completion of step 58, method 50 may proceed again to step 52.

Although FIG. 5 discloses a particular number of steps to be taken with respect to method 50, method 50 may be executed with greater or fewer steps than those depicted in FIG. 5. In addition, although FIG. 5 discloses a certain order of steps to be taken with respect to method 50, the steps comprising method 50 may be completed in any suitable order.

Method 50 may be implemented using comparison block 42 or any other system operable to implement method 50. In certain embodiments, method 50 may be implemented partially or fully in software and/or firmware embodied in computer-readable media.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An integrated circuit for implementing at least a portion of a personal audio device, comprising:
a first output for providing a first output signal to a first transducer including both a first source audio signal for playback to a listener and a first anti-noise signal for countering the effect of ambient audio sounds in an acoustic output of the first transducer;
a first error microphone input for receiving a first error microphone signal indicative of the output of the first transducer and the ambient audio sounds at the first transducer;
a second output for providing a second output signal to a second transducer including both a second source audio signal for playback to the listener and a second anti-noise signal for countering the effect of ambient audio sounds in an acoustic output of the second transducer;
a second error microphone input for receiving a second error microphone signal indicative of the output of the second transducer and the ambient audio sounds at the second transducer; and
a processing circuit that implements:
a first secondary path estimate adaptive filter for modeling an electro-acoustic path of the first source audio signal through the first transducer and having a response that generates a first secondary path estimate signal from the first source audio signal;
a first coefficient control block that shapes the response of the first secondary path estimate adaptive filter in conformity with the first source audio signal and a first playback corrected error by adapting the response of the first secondary path estimate filter to minimize the first playback corrected error, wherein the first playback corrected error is based on a difference between the first error microphone signal and the first secondary path estimate signal;
a second secondary path estimate adaptive filter for modeling an electro-acoustic path of the second source audio signal through the second transducer and having a response that generates a second secondary path estimate signal from the second source audio signal;
a second coefficient control block that shapes the response of the second secondary path estimate adaptive filter in conformity with the second source audio signal and a second playback corrected error by adapting the response of the second secondary path estimate filter to minimize the second playback corrected error, wherein the second playback corrected error is based on a difference between the second error microphone signal and the second secondary path estimate signal;
a first filter that generates the first anti-noise signal to reduce the presence of the ambient audio sounds at the acoustic output of the first transducer based at least on the first playback corrected error;
a second filter that generates the second anti-noise signal to reduce the presence of the ambient audio sounds at the acoustic output of the second transducer based at least on the second playback corrected error; and
a comparison block that compares the response of the first secondary path estimate adaptive filter and the response of the second secondary path estimate adaptive filter.

2. The integrated circuit of claim 1, wherein comparison of the response of the first secondary path estimate adaptive filter and the response of the second secondary path estimate adaptive filter is indicative of a proximity of each of the first transducer and the second transducer to a respective ear of the listener.

3. The integrated circuit of claim 1, wherein comparison of the response of the first secondary path estimate adaptive filter and the response of the second secondary path estimate adaptive filter is indicative of a quality of an acoustic seal between each of the first transducer and the second transducer to a respective ear of the listener.

4. The integrated circuit of claim 1, wherein the processing circuit is configured to alter, responsive to the response of the first secondary path estimate adaptive filter and the response of the second secondary path estimate adaptive filter differing by more than a predetermined threshold, at least one of:
the first anti-noise signal, wherein such alteration is independent of a response of the first filter; and
the second anti-noise signal, wherein such alteration is independent of a response of the second filter.

5. The integrated circuit of claim 4, wherein the processing circuit is further configured to, responsive to altering the first-anti-noise signal in response to the response of the first secondary path estimate adaptive filter and the response of the second secondary path estimate adaptive filter differing by more than a predetermined threshold, resetting coefficients of the first coefficient control block to be substantially equal to those of the second coefficient control block.

6. The integrated circuit of claim 4, wherein the processing circuit is configured to attenuate at least one of the first anti-noise signal and the second anti-noise signal responsive to the response of the first secondary path estimate adaptive filter and the response of the second secondary path estimate adaptive filter differing by more than a predetermined threshold.

7. The integrated circuit of claim 6, wherein attenuating at least one of the first anti-noise signal and the second anti-noise signal comprises muting at least one of the first anti-noise signal and the second anti-noise signal.

8. The integrated circuit of claim 6, further comprising:
a first reference microphone input for receiving a first reference microphone signal indicative of the ambient audio sounds at the acoustic output of the first transducer; and
a second reference microphone input for receiving a second reference microphone signal indicative of the ambient audio sounds at the acoustic output of the second transducer;
wherein:
the response of the first filter generates the first anti-noise signal from the first reference microphone signal to reduce the presence of the ambient audio sounds at the acoustic output of the first transducer; and
the response of the second filter generates the second anti-noise signal from the second reference microphone signal to reduce the presence of the ambient audio sounds at the acoustic output of the second transducer;
a first anti-noise path coefficient control block that shapes the response of the first filter in conformity with the first error microphone signal and the first reference microphone signal by adapting the response of the first filter to minimize the ambient audio sounds in the first error microphone signal;
a second anti-noise path coefficient control block that shapes the response of the second filter in conformity with the second error microphone signal and the second reference microphone signal by adapting the response of the second filter to minimize the ambient audio sounds in the second error microphone signal; and
further wherein the processing circuit is configured to:
freeze adaptation of the response of the first filter when the processing circuit attenuates the first anti-noise signal; and
freeze adaptation of the response of the second filter when the processing circuit attenuates the second anti-noise signal.

9. The integrated circuit of claim 1, further comprising:
a first reference microphone input for receiving a first reference microphone signal indicative of the ambient audio sounds at the acoustic output of the first transducer; and
a second reference microphone input for receiving a second reference microphone signal indicative of the ambient audio sounds at the acoustic output of the second transducer;
wherein:
the response of the first filter generates the first anti-noise signal from the first reference microphone signal to reduce the presence of the ambient audio sounds at the acoustic output of the first transducer; and
the response of the second filter generates the second anti-noise signal from the second reference microphone signal to reduce the presence of the ambient audio sounds at the acoustic output of the second transducer;
a first anti-noise path coefficient control block that shapes the response of the first filter in conformity with the first error microphone signal and the first reference microphone signal by adapting the response of the first filter to minimize the ambient audio sounds in the first error microphone signal;
a second anti-noise path coefficient control block that shapes the response of the second filter in conformity with the second error microphone signal and the second reference microphone signal by adapting the response of the second filter to minimize the ambient audio sounds in the second error microphone signal; and
further wherein the processing circuit is configured to reset coefficients of at least one of the first anti-noise path coefficient control block and the second anti-noise path coefficient control block to respective initial values responsive to the response of the first secondary path estimate adaptive filter and the response of the second secondary path estimate adaptive filter differing by more than a predetermined threshold.

10. A method for canceling ambient audio sounds in the respective proximities of transducers associated with a personal audio device, the method comprising:
receiving a first error microphone signal indicative of an output of a first transducer and the ambient audio sounds at the first transducer;
receiving a second error microphone signal indicative of an output of a second transducer and the ambient audio sounds at the second transducer;
generating a first secondary path estimate signal from a first source audio signal by filtering the first source audio signal with a first secondary path estimate filter for modeling an electro-acoustic path of the first source audio signal through the first transducer, wherein a response of the first secondary path estimate adaptive filter is shaped in conformity with the first source audio signal and a first playback corrected error by adapting the response of the first secondary path estimate filter to minimize the first playback corrected error, wherein the first playback corrected error is based on a difference between the first error microphone signal and the first secondary path estimate signal;
generating a second secondary path estimate signal from a second source audio signal by filtering the second source audio signal with a second secondary path estimate filter for modeling an electro-acoustic path of the second source audio signal through the second transducer wherein a response of the second secondary path estimate adaptive filter is shaped in conformity with the second source audio signal and a second playback corrected error by adapting the response of the second secondary path estimate filter to minimize the second playback corrected error, wherein the second playback corrected error is based on a difference between the second error microphone signal and the second secondary path estimate signal;
generating a first anti-noise signal to reduce the presence of the ambient audio sounds at the acoustic output of the first transducer based at least on the first playback corrected error;
generating a second anti-noise signal to reduce the presence of the ambient audio sounds at the acoustic output of the second transducer based at least on the second playback corrected error; and
comparing the response of the first secondary path estimate adaptive filter and the response of the second secondary path estimate adaptive filter.

11. The method of claim 10, further comprising:
combining the first anti-noise signal with the first source audio signal to generate a first audio signal provided to the first transducer; and
combining the second anti-noise signal with the second source audio signal to generate a second audio signal provided to the second transducer.

12. The method of claim 10, wherein comparing the response of the first secondary path estimate adaptive filter and the response of the second secondary path estimate adaptive filter provides an indication of a proximity of each of the first transducer and the second transducer to a respective ear of a listener of the personal audio device.

13. The method of claim 10, wherein comparing the response of the first secondary path estimate adaptive filter and the response of the second secondary path estimate adaptive filter provides an indication of a quality of an acoustic seal between each of the first transducer and the second transducer to a respective ear of the listener.

14. The method of claim 10, further comprising altering, responsive to the response of the first secondary path estimate adaptive filter and the response of the second secondary path estimate adaptive filter differing by more than a predetermined threshold, at least one of:
the first anti-noise signal, wherein such alteration is independent of a response of the first filter; and
the second anti-noise signal, wherein such alteration is independent of a response of the second filter.

15. The method of claim 14, further comprising, responsive to altering the first-anti-noise signal in response to the response of the first secondary path estimate adaptive filter and the response of the second secondary path estimate adaptive filter differing by more than a predetermined threshold, resetting coefficients of the first coefficient control block to be substantially equal to those of the second coefficient control block.

16. The method of claim 14, further comprising attenuating at least one of the first anti-noise signal and the second anti-noise signal responsive to the response of the first secondary path estimate adaptive filter and the response of the second secondary path estimate adaptive filter differing by more than a predetermined threshold.

17. The method of claim 16, wherein attenuating at least one of the first anti-noise signal and the second anti-noise signal comprises muting at least one of the first anti-noise signal and the second anti-noise signal.

18. The method of claim 16, further comprising:
receiving a first reference microphone signal indicative of the ambient audio sounds at the acoustic output of the first transducer; and
receiving a second reference microphone signal indicative of the ambient audio sounds at the acoustic output of the second transducer;
wherein:
a response of a first filter generates the first anti-noise signal from the first reference microphone signal to reduce the presence of the ambient audio sounds at the acoustic output of the first transducer; and
a response of a second filter generates the second anti-noise signal from the second reference microphone signal to reduce the presence of the ambient audio sounds at the acoustic output of the second transducer;
shaping, by a first anti-noise path coefficient control block, the response of the first filter in conformity with the first error microphone signal and the first reference microphone signal by adapting the response of the first filter to minimize the ambient audio sounds in the first error microphone signal, wherein adaptation of the response of the first filter is frozen during attenuation of the first anti-noise signal; and
shaping, by a second anti-noise path coefficient control block, the response of the second filter in conformity with the second error microphone signal and the second reference microphone signal by adapting the response of the second filter to minimize the ambient audio sounds in the second error microphone signal, wherein adaptation of the response of the second filter is frozen during attenuation of the second anti-noise signal.

19. The method of claim 10, further comprising:
receiving a first reference microphone signal indicative of the ambient audio sounds at the acoustic output of the first transducer; and
receiving a second reference microphone signal indicative of the ambient audio sounds at the acoustic output of the second transducer;
wherein:
a response of a first filter generates the first anti-noise signal from the first reference microphone signal to reduce the presence of the ambient audio sounds at the acoustic output of the first transducer; and
a response of a second filter generates the second anti-noise signal from the second reference microphone signal to reduce the presence of the ambient audio sounds at the acoustic output of the second transducer;
shaping, by a first anti-noise path coefficient control block, the response of the first filter in conformity with the first error microphone signal and the first reference microphone signal by adapting the response of the first filter to minimize the ambient audio sounds in the first error microphone signal;
shaping, by a second anti-noise path coefficient control block, the response of the second filter in conformity with the second error microphone signal and the second reference microphone signal by adapting the response of the second filter to minimize the ambient audio sounds in the second error microphone signal; and
resetting coefficients of at least one of the first anti-noise path coefficient control block and the anti-noise path second coefficient control block to respective initial values responsive to the response of the first secondary path estimate adaptive filter and the response of the second secondary path estimate adaptive filter differing by more than a predetermined threshold.

20. An integrated circuit for implementing at least a portion of a personal audio device, comprising:
a first output for providing a first output signal to a first transducer including both a first source audio signal for playback to a listener and a first anti-noise signal for countering the effect of ambient audio sounds in an acoustic output of the first transducer;
a first error microphone input for receiving a first error microphone signal indicative of the output of the first transducer and the ambient audio sounds at the first transducer;
a first reference microphone input for receiving a first reference microphone signal indicative of the ambient audio sounds at the acoustic output of the first transducer; and
a second output for providing a second output signal to a second transducer including both a second source audio signal for playback to the listener and a second anti-noise signal for countering the effect of ambient audio sounds in an acoustic output of the second transducer;
a second error microphone input for receiving a second error microphone signal indicative of the output of the second transducer and the ambient audio sounds at the second transducer;
a second reference microphone input for receiving a second reference microphone signal indicative of the ambient audio sounds at the acoustic output of the second transducer; and
a processing circuit that implements:
a first adaptive filter that generates the first anti-noise signal from the first reference microphone signal to reduce the presence of the ambient audio sounds at the acoustic output of the first transducer;
a second adaptive filter that generates the second anti-noise signal from the second reference microphone signal to reduce the presence of the ambient audio sounds at the acoustic output of the second transducer;
a first coefficient control block that shapes the response of the first adaptive filter in conformity with the first error microphone signal and the first reference microphone signal by adapting the response of the first adaptive filter to minimize the ambient audio sounds in the first error microphone signal;
a second coefficient control block that shapes the response of the second adaptive filter in conformity with the second error microphone signal and the second reference microphone signal by adapting the response of the second adaptive filter to minimize the ambient audio sounds in the second error microphone signal; and
a comparison block that compares the response of the first adaptive filter and the response of the second adaptive filter.

21. The integrated circuit of claim 20, wherein the processing circuit is configured to alter, responsive to the response of the first adaptive filter and the response of the second adaptive filter differing by more than a predetermined threshold, at least one of:
the first anti-noise signal, wherein such alteration is independent of a response of the first adaptive filter; and
the second anti-noise signal, wherein such alteration is independent of a response of the second adaptive filter.

22. A method for canceling ambient audio sounds in the respective proximities of transducers associated with a personal audio device, the method comprising:
receiving a first error microphone signal indicative of an output of a first transducer and the ambient audio sounds at the first transducer;
receiving a second error microphone signal indicative of an output of a second transducer and the ambient audio sounds at the second transducer;
receiving a first reference microphone signal indicative of the ambient audio sounds at the acoustic output of the first transducer;
receiving a second reference microphone signal indicative of the ambient audio sounds at the acoustic output of the second transducer;
generating, by a first adaptive filter, a first anti-noise signal from the first reference microphone signal to reduce the presence of the ambient audio sounds at the acoustic output of the first transducer;
generating, by a second adaptive filter, a second anti-noise signal from the second reference microphone signal to reduce the presence of the ambient audio sounds at the acoustic output of the second transducer;
shaping, by a first anti-noise path coefficient control block, a response of the first filter in conformity with the first error microphone signal and the first reference microphone signal by adapting the response of the first filter to minimize the ambient audio sounds in the first error microphone signal;
shaping, by a second anti-noise path coefficient control block, a response of the second filter in conformity with the second error microphone signal and the second reference microphone signal by adapting the response of the second filter to minimize the ambient audio sounds in the second error microphone signal; and
comparing the response of the first adaptive filter and the response of the second adaptive filter.

23. The method of claim 22, further comprising altering, responsive to the response of the first adaptive filter and the response of the second adaptive filter differing by more than a predetermined threshold, at least one of:
the first anti-noise signal, wherein such alteration is independent of a response of the first adaptive filter; and
the second anti-noise signal, wherein such alteration is independent of a response of the second adaptive filter.
